(19) United States
(12) Patent Application Publication
(10) Pub. No.: US 2005/0106078 A1
(43) Pub. Date: May 19, 2005

(54) Microchip pileup type chemical reaction system

(76) Inventors: Takehiko Kitamori, Tokyo (JP); Hideaki Hisamoto, Tokyo (JP); Yoshikuni Kikutani, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/473,336

(22) PCT Filed: Sep. 28, 2001
(86) PCT No.: PCT/JP01/08561

(30) Foreign Application Priority Data
Mar. 29, 2001 (JP) 200197328

(51) Int. Cl. B01J 19/00

(52) U.S. Cl. 422/130; 422/102

(57) ABSTRACT

A microchip pileup type chemical reaction system characterized in that a specified number of microchips, each having a reaction material liquid introducing section, a reaction product liquid discharge section and a reaction region, i.e. microchannels, interconnected therewith, are laid integrally in layers, the same kind of reaction material is introduced from the reaction material liquid introducing section into each microchip and the same kind of reaction product is collected from the reaction product liquid discharge section. The novel system for high efficiency chemical reaction makes the most use of the feature of microspace where general organic synthesis reaction is performed in the microchips while enabling mass synthesis.

### TECHNICAL FIELD

The present invention relates to a microchip pileup type chemical reaction system. Particularly, the invention relates to a microchip pileup type chemical reaction system that enables highly efficient chemical reactions yielding few by-products to be constructed as a large scale synthesis reaction system by taking advantage of microchannels having microspaces.

### BACKGROUND ART

It has been actively developed in recent years to form microchannels as fine grooves having an width of 500 μm or less on a several centimeters square substrate, and to use these microchannels as chemical reaction regions.

The present inventors have also noticed that the microchannel involves various advantages for highly efficient chemical reactions such as short molecular diffusion distances, large specific interface areas and small heat capacity, when the microspace of the liquid phase in the microchannel is considered to be a chemical reaction field. Accordingly, the present inventors have applied the microchannel reaction system to various intermolecular chemical reactions such as complexing reactions, solvent extraction, immunological reactions, enzyme reactions and ion-pair extraction reactions. Highly efficient chemical reactions are expected to be proceeded in such reaction field since substance transfer time is shortened, solid-liquid or liquid-liquid interface reactions become predominant, and heat energies are promptly transferred from or to the reaction system. However, few basic researches systematically investigating basic chemical reactions in the liquid phase in the micro-spaces have been reported today. While large scale synthesis rather than high efficiency should be particularly considered in usual organic synthesis reactions, substantially no relations between minute quantity of reactions in the microchip and large scale synthesis have been investigated.

Accordingly, the object of the invention is to enable large scale synthesis in the usual organic synthesis reactions carried out in the microchip, while realizing highly efficient chemical reactions by taking advantage of the features of the microspace.

### DISCLOSURE OF INVENTION

The present invention for solving the problems above provides a microchip pileup type chemical reaction system comprising a specified number of integrally laminated microchips each having reaction material liquid introducing sections, a reaction product liquid discharge section, and microchannels as regions communicating therewith. The same kind of reaction material is introduced from the reaction material liquid introducing sections into each microchip to perform the same kind of reaction in each reaction region microchannel, and the same kind of reaction product is collected from the reaction product liquid discharge section.

In the microchip pileup type chemical reaction system of the invention, the reaction material liquid introducing section of each microchip directly communicates with the reaction material liquid introducing section of a microchip laminated thereon or thereunder, or with the reaction material liquid introducing sections laminated thereon and thereunder. The reaction product liquid discharge section of each microchip directly communicates with the reaction product liquid discharge section of a microchip laminated thereon or thereunder, or with the reaction product liquid discharge sections laminated thereon and thereunder.

The microchip pileup type chemical reaction system of the invention comprises a specified number of integrally laminated microchip pileup members of the invention integrally assembled in parallel.

### BRIEF DESCRIPTION OF THE DRAWINGS

FIG. 1 is a perspective view showing an example of the system of the invention.

FIG. 2 illustrates the modes of introduction of the material liquid and discharge of the product liquid in the example shown in FIG. 1.

FIG. 3 is a perspective view showing an example different from the example shown in FIGS. 1 and 2.

FIG. 4 is a perspective view showing a further different example.

### BEST MODE FOR CARRYING OUT THE INVENTION

While the invention is featured as described above, embodiments of the invention will be described hereinafter.

Since the object of chemical synthesis is large scale synthesis in most of organic synthesis, it has been often pointed out that the absolute quantity of the product is important in utilizing the microchannel as a reaction field. However, a combination of “microchip” and “organic synthesis” that seems to be contradictory at first glance is actually compatible with each other considering that the reaction in the microchip is highly efficient. On the contrary, the microchip can exert a greater effect than using conventional reaction vessels. The invention enables the features to be realized.

No chemical technology investigations are not intrinsically needed in scale up, when the microchannel is used as the reaction field. A highly efficient demand-dependent reaction system may be constructed by laminating a specified number of microchips for complying with respective demands, and by assembling a plurality of microchip systems in parallel as disclosed in the invention.

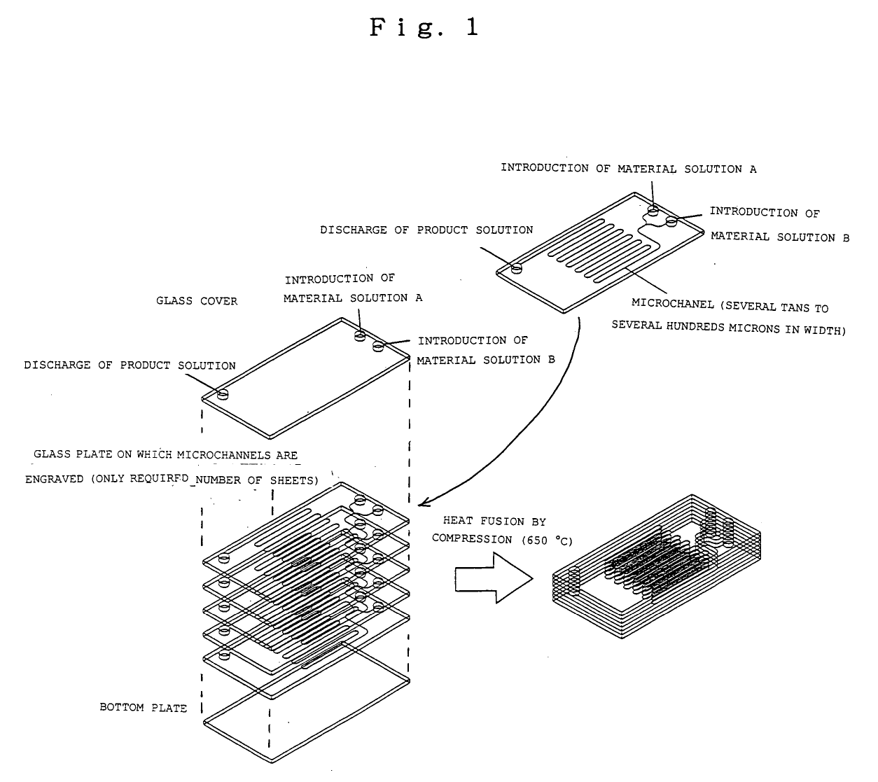

As described previously, the microchips, each providing introducing sections of the reaction material solutions (A) and (B) and a discharge section of the reaction product solution as well as a microchannels as a reaction region with an width of several tens to several hundreds microns that communicate with the introducing sections and discharge section, are integrally laminated as shown in FIG. 1 in the invention. The same kind of reaction material is introduced from the reaction material liquid introducing sections, the same kind of reaction is performed in the reaction region of each microchannel, and the same kind of reaction product is collected from the reaction product discharge section in the microchip pileup type chemical reaction system.

As for the integrally laminating the microchips, Pyrex glass plates are used as the substrates of the microchip, and the plates are fused by heating with compression. However, various methods such as those known in the art may be employed depending on the kind of the substrate.

In the microchip pileup type chemical reaction system of the invention as shown in FIG. 1, the reaction material liquid introducing section of each microchip may directly communicate with the reaction material liquid introducing section of a microchip laminated thereon or thereunder, or with the reaction material liquid introducing sections laminated thereon and thereunder. Alternatively, the reaction product liquid discharge section of each microchip may directly communicate with the reaction product liquid discharge sections of the microchips laminated thereon or thereunder, or with the reaction product liquid discharge sections laminated thereon and thereunder.

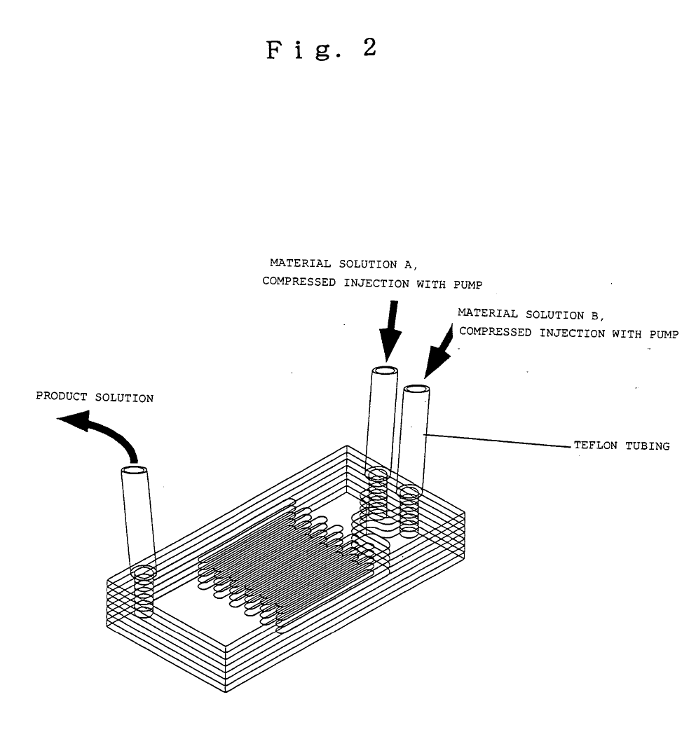

In the system as described above, the microchannel in each floor is perforated with vertical holes having a sufficiently larger diameter than the microchannel size as shown in FIG. 2. Consequently, the holes serve as pools for buffering the solution to send to each floor, and as pools for collecting the reaction product to discharge to the outside. For example, a Teflon tube is connected to each vertical hole, the reaction product solution is collected after allowing the material solution to react by flowing it with a pressurizing pump. As a result, a plurality of microchannels each having the same function as a single microchip can be operated in parallel, and the yield of the reaction product per unit time may be increased by taking advantage of the characteristics of the reactor having several tens to several hundreds microns of microchannels.

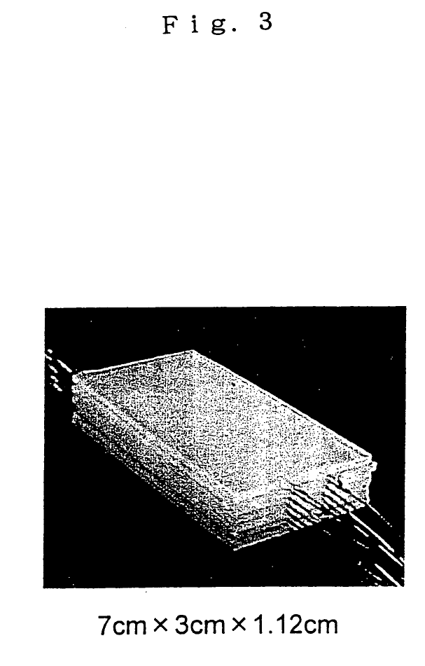

In another aspect of the invention, the material solution introducing section and reaction product solution discharge section may be connected to each microchip or to an assembly of several microchips as shown in FIG. 3 in order to independently introduce and discharge the solutions, instead of forming the reaction system as a communicating structure.

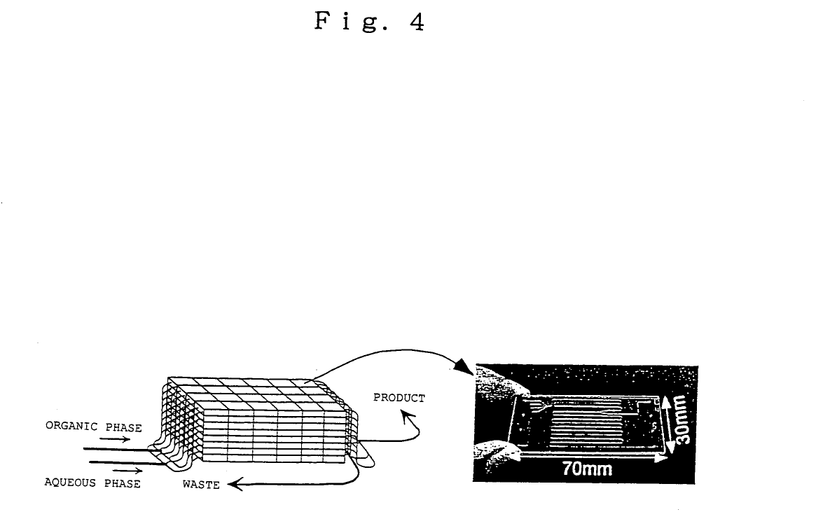

Alternatively, the microchip pileup type chemical reaction system may be constructed so that a specified number of integrally laminated microchip pileup members are integrally assembled in parallel as shown in FIG. 4.

According to the pileup type chemical reaction system described in the embodiments above, productivity of the reaction is improved by taking advantage of microspace reactions while enabling the production scale to be flexibly controlled by permitting simple parallel synthesis to be proceeded. Consequently, large scale synthesis is possible while enabling the risk of excess production by large scale synthesis to be avoided. It is also possible to simplify the system and rationalize the development process.

From the features as described above, the invention is applicable to not only the mass production system, synthetic production of pharmaceuticals but also to a small scale production system by which many kinds of required products are synthesized in required quantities.

The invention will be described in detail in an example in which a pigment is synthesized in an oil/water two-phase flow.

In this reaction system, a resorcinol derivative dissolved in an oil phase is partitioned between the oil phase and aqueous phase, and the major product formed is extracted again into the oil phase after a diazo coupling reaction between the resorcinol derivative and a diazonium salt. The reaction efficiency was evaluated by analyzing the organic phase after the reaction using a microchip comprising Y-shaped microchannels (a width of 250 μm and a depth of 100 μm) in a plane view.

It was confirmed that the reaction yield is evidently higher in the reaction in the microchips than in a macroscopic scale reaction. This is because the residence time of the major reaction product in the aqueous phase is so short in the reaction in the microchip having a large specific interface area that the major product formed is efficiently extracted into the organic phase. Since side reactions hardly advances, the reaction yield is considered to be relatively improved.

Investigations of chemical engineering conditions are not required at all in the synthesis system using the microchip, and the microchip system is applicable to mass production by simply piling up the plate-shaped chips, for example as shown in FIG. 4. The pileup space required for realizing an annual production scale of 1 ton is calculated to be about 0.4 m³ based on the calculated productivity per one sheet of chip using the high yield synthesis system investigated as described above. It was shown that a small space is sufficient for mass production.

Accordingly, it is easy to construct a demand-dependent synthesis system by which many kinds of required products are synthesized in required quantities by high yield synthesis based on continuous feed of the materials and adjustment of the pileup number of the microchip sheets, which have been difficult to realize in the conventional chemical engineering.

It has been a leading fashion for investigating the micro-reactor to notice mixing efficiencies between two liquids (molecular diffusion), and prompt removal of the heat of reaction. However, the invention has confirmed that high speed, high yield synthetic reactions with few by-products are possible by taking advantage of the microspaces, and the method of the invention is also compatible with mass production.

Industrial Applicability

As described in detail above, the invention provides a novel system for highly efficient chemical reactions by taking advantage of the microspaces, whereby large scale synthesis is possible by performing universally applicable organic synthesis reactions in the microchips.

1. A microchip pileup type chemical reaction system comprising a specified number of integrally laminated microchips each having reaction material liquid introducing sections, a reaction product liquid discharge section, and microchannels as regions communicating therewith, wherein the same kind of reaction materials are introduced from the reaction material liquid introducing sections into each microchip to perform the same kind of reaction in each reaction region microchannel, and the same kind of reaction product is collected from the reaction product liquid discharge section.

2. The microchip pileup type chemical reaction system according to claim 1, wherein the reaction material liquid introducing section of each microchip directly communicates with the reaction material liquid introducing section of the microchip laminated thereon or thereunder, or with the reaction material liquid introducing sections laminated thereon and thereunder.

3. The microchip pileup type chemical reaction system according to claim 1, wherein the reaction product liquid discharge section of each microchip directly communicates with the reaction product liquid discharge section of a microchip laminated thereon or thereunder, or with the reaction product liquid discharge sections laminated thereon and thereunder.

4. The microchip pileup type chemical reaction system comprising a specified number of integrally laminated microchip pileup members according to claim 1 integrally assembled in parallel.

5. The microchip pileup type chemical reaction system according to claim 2, wherein the reaction product liquid discharge section of each microchip directly communicates with the reaction product liquid discharge section of a microchip laminated thereon or thereunder, or with the reaction product liquid discharge sections laminated thereon and thereunder.

6. The microchip pileup type chemical reaction system comprising a specified number of integrally laminated microchip pileup members according to claim 2 integrally assembled in parallel.

7. The microchip pileup type chemical reaction system comprising a specified number of integrally laminated microchip pileup members according to claim 3 integrally assembled in parallel.
